(19) United States
(12) Patent Application Publication
(10) Pub. No.: US 2023/0324621 A1
(43) Pub. Date: Oct. 12, 2023

(54) OPTICAL SWITCH

(71) Applicant: NIPPON TELEGRAPH AND TELEPHONE CORPORATION, Tokyo (JP)

(72) Inventors: Chisato FUKAI, Musashino-shi, Tokyo (JP); Kunihiro TOGE, Musashino-shi, Tokyo (JP); Tomohiro KAWANO, Musashino-shi, Tokyo (JP)

(73) Assignee: NIPPON TELEGRAPH AND TELEPHONE CORPORATION, Tokyo (JP)

(21) Appl. No.: 18/018,705

(22) PCT Filed: Aug. 3, 2020
(86) PCT No.: PCT/JP2020/029717

§ 371 Date: Jan. 30, 2023

(51) Int. Cl. G02B 6/35; G02B 6/02

(52) U.S. Cl. CPC G02B 6/3512; G02B 6/02042; G02B 6/3504

(57) ABSTRACT

The present disclosure aims to provide an optical switch that has low power consumption, and can achieve stable optical characteristics to cope with external factors with a mechanism that does not require any complicated assembly process. An optical switch according to the present disclosure characteristically includes: an optical coupling portion including: a multi-core optical fiber that has a central core at the center of an optical fiber and a plurality of outer cores on the circumference of the identical circle centering around the optical fiber in a fiber cross-section; a mirror that is disposed in front of an end face of the multi-core optical fiber, and couples one of the outer cores with the central core to form one optical path; and a cylindrical member that has an end face to which the mirror is fixed; and a rotation mechanism that rotates the multi-core optical fiber or the cylindrical member in an axial direction of the multi-core optical fiber, and switches the optical path in the optical coupling portion.

### TECHNICAL FIELD

The present invention relates to an optical switch to be used mainly for switching paths among optical fiber lines using single-mode optical fibers in an optical fiber network.

### BACKGROUND ART

For an all-optical switch that performs path switching while keeping light as it is, various systems have been suggested as disclosed in Non Patent Literature 1, for example. Among these systems, an optical-fiber-type mechanical optical switch that controls abutment between optical fibers or optical connectors with a robot arm, a motor, or the like is inferior to the other systems in that the switching speed is low, but has many aspects at which the mechanical optical switch is superior to the other systems in terms of low loss, low wavelength dependence, multi-port properties, and a self-holding function of holding the switching state at a time when the power supply is stopped. Representative examples of such structures include a system in which a stage using an optical fiber V-shaped groove is moved in parallel, for example, a system in which a mirror or a prism is moved in parallel or is made to change its angle so as to selectively couple an incident optical fiber with a plurality of exit optical fibers, and a system in which a jumper cable having an optical connector is connected using a robot arm.

Also, a method using a multi-core fiber as an optical path for performing switching has been suggested. For example, by combining a three-dimensional MEMS optical switch with a multi-core fiber (see Non Patent Literature 2, for example), it becomes possible to collectively switch multiple paths, for example. Further, by rotating a cylindrical ferrule into which a multi-core fiber is inserted to perform switching (see Patent Literature 1, for example), it is possible to make optical components such as lenses and prisms unnecessary, and simplify the configuration.

### CITATION LIST

### Patent Literature

Patent Literature 1: JP 2-82212 A

### Non Patent Literature

Non Patent Literature 1: M.Ctepanovsky, “A Comparative Review of MEMS-Based Optical Cross-Connects for All-Optical Networks From the Past to the Present Day,” IEEE Communications Surveys & Tutorials,vol.21,no.3,pp.2928-2946,2019.
Non Patent Literature 2: Kenji Hiruma, Toshiki Sugawara, Kenichi Tanaka, Etsuko Nomoto, and Yong Lee, “Proposal of High-capacity and High-reliability Optical Switch Equipment with Multi-core Fibers”, OECC/PS 2013, THT1-2.

### SUMMARY OF INVENTION

### Technical Problem

However, the conventional technology disclosed in Non Patent Literature 1 has a problem in that it is difficult to further lower power consumption, reduce size, and lower costs. Specifically, in the above-mentioned system that moves a stage having an optical fiber V-shaped groove or a prism in parallel, a motor is normally used as a drive source. However, since the mechanism linearly moves a heavy object such as a stage, a torque of a certain level or higher is required for the motor, and power consumption for obtaining the appropriate output is required to maintain the necessary torque. Also, since optical axis alignment using a single-mode optical fiber requires an accuracy of about 1 µm or less, rotational motion of the motor needs to be converted into linear motion in submicron steps with a mechanism that converts rotational motion of a motor into linear motion (a ball screw is normally used for such a mechanism). The optical fiber pitch of an output-side optical fiber array that is normally used is about 125 µm, which is the cladding outer diameter of an optical fiber, or is about 250 µm, which is the coating outer diameter of an optical fiber. If the number of installed optical fibers is increased while this optical fiber pitch is maintained, the optical fiber array on the output side becomes larger. As a result, the distance of linear motion becomes longer, the actual drive time of the motor has to be made longer, and the power consumption becomes higher. Therefore, such an optical-fiber-type mechanical optical switch normally requires electric power of several hundreds of mW or more. Meanwhile, the robot arm system using an optical connector has a problem in that a large amount of electric power, like several tens of watts or more, is required for the robot arm that controls insertion and removal of the optical connector or a ferrule.

Also, in the optical path switching using a multi-core fiber as disclosed in Non Patent Literature 2, an anti-vibration mechanism for obtaining stable optical characteristics to cope with external factors such as vibration is additionally required in the process of manufacturing the optical switch, and the assembly process is also complicated.

Further, in the optical path switching using a cylindrical ferrule into which a multi-core fiber is inserted as disclosed in Patent Literature 1, the ferrule is tightly inserted into a sleeve to align the central axis of the ferrule, and a large amount of energy is required for causing rotation due to the frictional force between the ferrule and the sleeve. Therefore, a large amount of power is required. In addition to that, the optical fiber is twisted by the repetitive switching through the rotation.

To solve the above problems, the present invention aims to provide an optical switch that has low power consumption, and can achieve stable optical characteristics to cope with external factors with a mechanism that does not require any complicated assembly process.

### Solution to Problem

To achieve the above objective, an optical switch of the present disclosure includes: a mechanism that axially rotates with ease a cylindrical member having a mirror on an end face thereof or a multi-core optical fiber having a central core and outer cores, to switch optical paths through reflection by the mirror; and a clearance for eliminating the loss to be caused by the rotation.

Specifically, an optical switch according to the present disclosure includes: an optical coupling portion including: a multi-core optical fiber that has a central core at the center of an optical fiber and a plurality of outer cores on the circumference of the identical circle centering around the optical fiber in a fiber cross-section; a mirror that is disposed in front of an end face of the multi-core optical fiber, and couples one of the outer cores with the central core to form one optical path; and a cylindrical member that has an end face to which the mirror is fixed; and a rotation mechanism that rotates the multi-core optical fiber or the cylindrical member in an axial direction of the multi-core optical fiber, and switches the optical path in the optical coupling portion.

For example, in the optical switch according to the present disclosure, the optical coupling portion may further include: a ferrule in which the multi-core optical fiber is provided; and a cylindrical sleeve into which the ferrule and the cylindrical member are inserted so that the end face of the multi-core optical fiber and the mirror face each other. A predetermined gap may be formed between the outer diameter of the cylindrical member and the inner diameter of the sleeve.

For example, in the optical switch according to the present disclosure, the end on the opposite side of the multi-core optical fiber from the end face included in the optical coupling portion may be connected to a fan-in or fan-out optical device connected to an input/output single-core optical fiber having a single core.

For example, the optical switch according to the present disclosure may further include a flange that holds the cylindrical member via a bearing.

For example, the optical switch according to the present disclosure may further include a flange that holds the ferrule via a bearing.

For example, the optical switch according to the present disclosure may further include an actuator that rotates the rotation mechanism at constant angle steps, and stops the rotation mechanism at a desired angle step.

According to the present invention, the mechanism that easily rotates only either the multi-core optical fiber or the cylindrical member in an axial direction, and the gap and the clearance for eliminating any loss associated with rotation are provided. Thus, the energy required by the actuator, which is the torque output, can be minimized, and power consumption can be lowered. Also, the amount of optical axis misalignment in a direction other than the direction of axial rotation of the cylindrical member is restricted by the sleeve in the optical coupling portion. Thus, stable optical characteristics can be achieved to cope with external factors such as vibration. Further, the optical switch does not include any special anti-vibration mechanism. Accordingly, an optical switch that is economical and compact with excellent assembly workability can be formed with general materials widely used in optical connector products and optical switch products, such as a ferrule, a sleeve, and a mirror.

Note that the respective inventions described above can be combined as appropriate.

### Advantageous Effects of Invention

According to the present disclosure, it is possible to provide an optical switch that has low power consumption, and can achieve stable optical characteristics to cope with external factors with a mechanism that does not require any complicated assembly process.

### BRIEF DESCRIPTION OF DRAWINGS

FIG. 1 is a diagram illustrating an example of an embodiment of the present invention.

FIG. 2 is a block configuration diagram illustrating the embodiment of the present invention.

FIG. 3 is a schematic diagram illustrating the structures of multi-core optical fibers according to the embodiment of the present invention.

FIG. 4 is a diagram illustrating the optical path in an optical coupling portion according to the embodiment of the present invention.

FIG. 5 is a schematic diagram illustrating in detail the optical coupling portion according to the embodiment of the present invention.

FIG. 6 is a schematic diagram illustrating an engaged mode of an optical coupling portion according to a first embodiment of the present invention.

FIG. 7 is a diagram illustrating an example relationship of the maximum static angle accuracy with respect to the core position radius.

FIG. 8 is a schematic diagram illustrating an engaged mode of an optical coupling portion according to a second embodiment of the present invention.

FIG. 9 is a front view of a light reflecting portion according to the second embodiment of the present invention.

### DESCRIPTION OF EMBODIMENTS

Embodiments of the present disclosure will be described below in detail, with reference to the drawings. Note that the present invention is not limited to the embodiments described below. These embodiments are merely examples, and the present disclosure can be carried out in a form with various modifications and improvements based on the knowledge of those skilled in the art. Note that components denoted by the same reference numerals in the specification and the drawings indicate the same components.

### First Embodiment

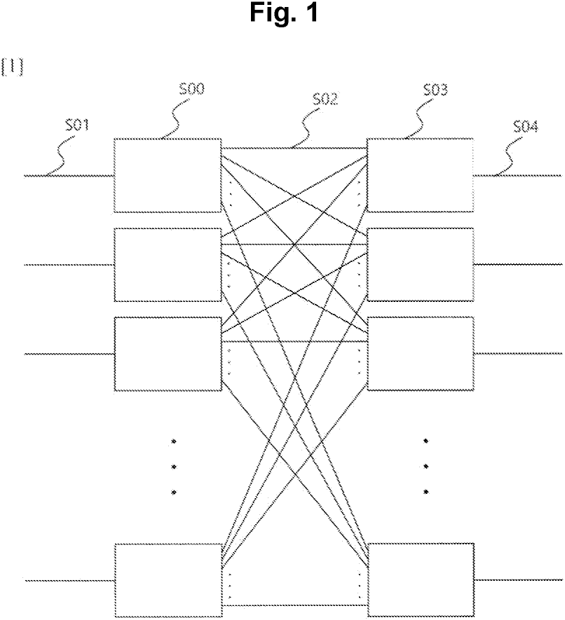

An example usage mode of an optical switch according to this embodiment is illustrated in FIG. 1. This embodiment concerns a mode in which light is input from S01, and is output to S04. With the optical switch, the direction of light may be reversed. According to the present invention, an input-side optical fiber S01 connected to a former-stage optical switch S00 can be switched to a specific port of an inter-optical-switch optical fiber S02 at the former-stage optical switch S00, and the port of the inter-optical-switch optical fiber S02 can be switched to a desired output-side optical fiber S04 at a latter-stage optical switch S03. The present invention relates to an optical switch corresponding to the former-stage optical switch S00 and the latter-stage optical switch S03. Hereinafter, the former-stage optical switch S00 will be referred to simply as the optical switch S00, and the latter-stage optical switch S03 will be referred to simply as the optical switch S03. In the description below, the optical switches S00 and S03 according to this embodiment will be explained.

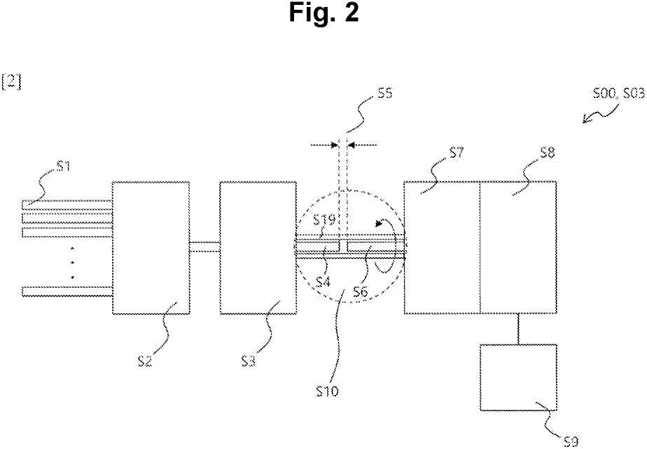

The outline of the configurations and operations of the optical switches S00 and S03 according to this embodiment is now described with reference to FIG. 2. FIG. 2 illustrates a block configuration diagram of the optical switches S00 and S03 according to this embodiment.

The optical switches S00 and S03 illustrated in FIG. 2 include an input/output single-core optical fiber S1, a fan-in or fan-out optical device S2, a bundled optical fiber S4 formed by melting and stretching a multi-core optical fiber including a plurality of cores or a plurality of single-core optical fibers (hereinafter, the “bundled optical fiber S4 formed by melting and stretching a multi-core optical fiber including a plurality of cores or a plurality of single-core optical fibers” will be referred to as the “multi-core optical fiber S4”), a cylindrical member S6, and an optical coupling portion S10 including an end of the multi-core optical fiber S4 and an end of the cylindrical member S6. The optical switches S00 and S03 also include an anti-rotation mechanism S3, a rotation mechanism S7, an actuator S8, and a control circuit S9, to rotate only the cylindrical member S6. The anti-rotation mechanism S3 and the rotation mechanism S7 may be included in the optical coupling portion S10.

As illustrated in FIG. 2, the multi-core optical fiber S4 is fixed by the anti-rotation mechanism S3 so as not to axially rotate. The cylindrical member S6 has the rotation mechanism S7 attached thereto, and can freely rotate in an axial direction. The actuator S8 that performs angle rotation rotates the cylindrical member S6 in accordance with a signal supplied from the control circuit S9. Further, the optical coupling portion S10 has a gap S5 formed therein, and is designed not to interfere with the multi-core optical fiber S4 even when the cylindrical member S6 rotates.

In the optical switches S00 and S03, the end of the multi-core optical fiber S4 on the opposite side from the end face included in the optical coupling portion S10 is connected to the fan-in or fan-out optical device S2 connected to the input/output single-core optical fiber S1 having a single core. As illustrated in FIG. 2, in the optical switches S00 and S03, the input/output single-core optical fiber S1 is connected to the core of the multi-core optical fiber S4 via the fan-in or fan-out optical device S2.

Although the multi-core optical fiber S4 is fixed, and the cylindrical member S6 is rotated in the above description, the extra length from the fan-in or fan-out optical device S2 to the optical coupling portion S10 may be increased beforehand to fix the cylindrical member S6 and rotate the multi-core optical fiber S4. The following is a description of the optical switches S00 and S03 that fix the multi-core optical fiber S4 and rotate the cylindrical member S6 as illustrated in FIG. 2.

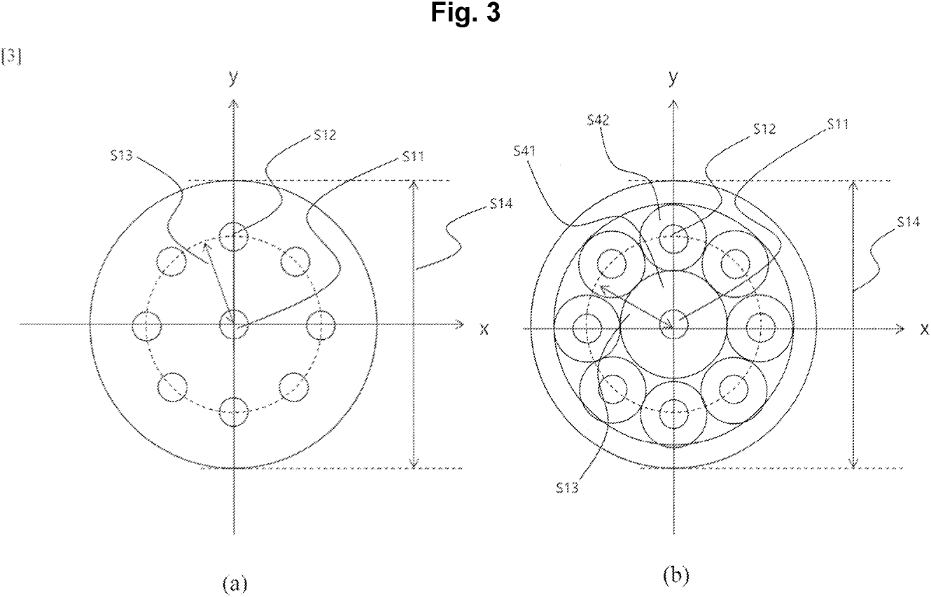

The optical switches S00 and S03 according to this embodiment are now described in detail, with reference to FIGS. 3 to 7. FIG. 3 illustrates cross-sections of the multi-core optical fiber S4. FIG. 3(a) illustrates a multi-core optical fiber including nine cores, and FIG. 3(b) illustrates a bundled optical fiber. The multi-core optical fiber S4 may be in either of the forms illustrated in FIGS. 3A and 3B. As illustrated in FIG. 3, the multi-core optical fiber S4 characteristically includes a central core S11 at the center of the optical fiber, and a plurality of outer cores S12 having their centers located on the circumference of a circle that centers around the center of the optical fiber and has a core position radius S13. Although FIG. 3 illustrates examples of a multi-core optical fiber and a bundled optical fiber including a total of nine cores. However, the central core S11 is only required to be located at the center of the optical fiber, and the center of each outer core S12 is only required to be located on the circumference of the circle that centers around the center of the optical fiber and has the core position radius S13. As long as these conditions are satisfied, the number and the positions of the cores in the optical fiber are not limited to the above example. Note that the single-core optical fibers constituting the bundled optical fiber in FIG. 3(b) each have a center cladding S41 or an outer cladding S42.

Here, it is critical for an optical switch to maximize the optical coupling rate of the optical coupling portion S10, and the central core S11 and the outer cores S12 of the multi-core optical fiber S4 preferably have the same optical characteristics having similar mode field radiuses, but may have different optical characteristics as long as optical coupling is possible. Further, the optical fiber cladding diameter S14 may be 125 µm, which is widely used for communications, or may be an enlarged cladding diameter for enabling the use of a large number of cores, such as 190 µm, for example.

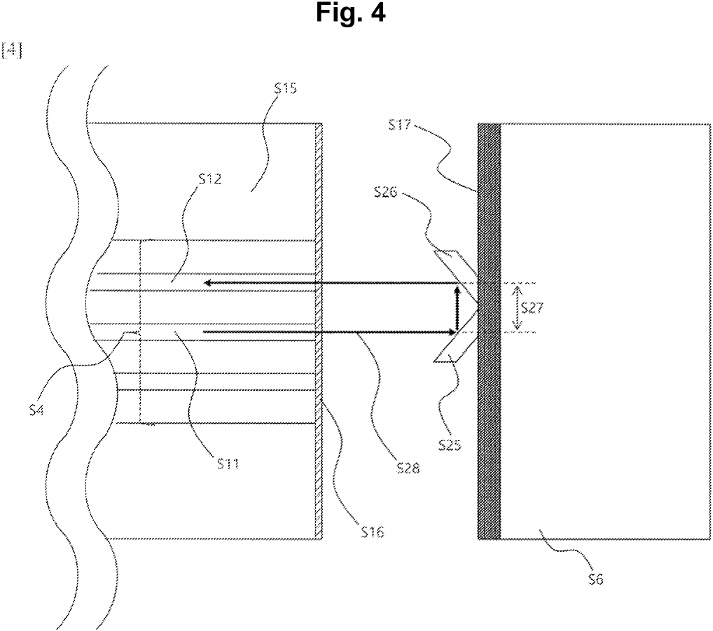

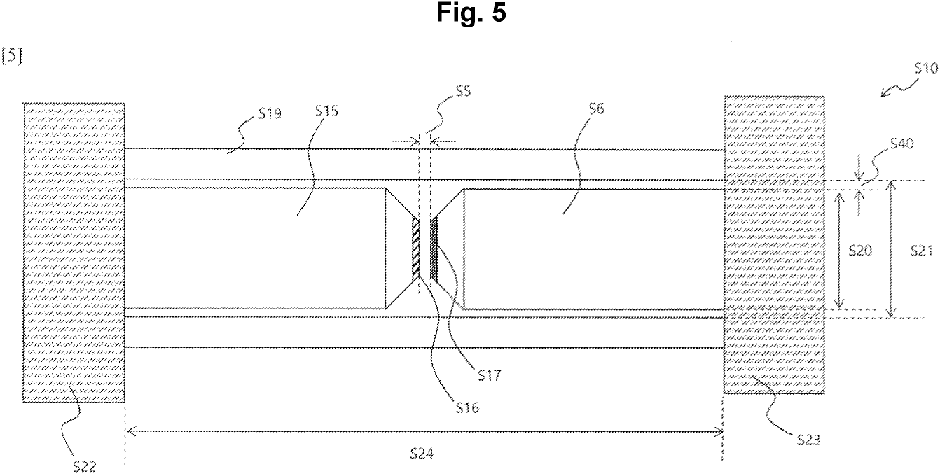

The optical coupling portion S10 according to the embodiment of the present invention is now described in detail, with reference to FIGS. 4 and 5. First, a light reflecting portion S17, an optical path S28, and the multi-core optical fiber S4 in the optical coupling portion S10 according to the embodiment of the present invention are described, with reference to FIG. 4. FIG. 4 is a diagram illustrating the vicinities of an end face of the multi-core optical fiber S4 and an end face of the cylindrical member S6 in the optical coupling portion S10. The optical coupling portion S10 includes: the above-described multi-core optical fiber S4 including the central core S11 at the center of the optical fiber and the plurality of outer cores S12 located on the circumference of the same circle centering around the center of the optical fiber in a fiber cross-section; mirrors S25 and S26 that are disposed in front of the end face of the multi-core optical fiber S4, and couple one of the outer cores S12 with the central core S11 to form one optical path S28; and the cylindrical member S6 having the end face to which the mirrors S25 and S26 are fixed.

Specifically, the light reflecting portion S17 formed on the end face of the cylindrical member S6 has the mirrors S25 and S26. The mirrors S25 and S26 are fixed at positions that satisfy the following three conditions in the light reflecting portion S17. (1) The mirror S25 faces the central core S11. (2) The mirror S26 faces one of the outer cores S12. (3) The light-reflective center-to-center distance S27 illustrated in FIG. 4 is equal to the core position radius S13 of the multi-core optical fiber S4 illustrated in FIG. 3. By satisfying these three conditions, the optical switches S00 and S03 can rotate the cylindrical member S6 to move the mirror S26 along the circumference of the circle on which the outer cores S12 are disposed. Since the mirror S26 and the outer cores S12 are always located on the same circumference, the optical switches S00 and S03 can cause the mirror S26 and any desired outer core S12 to face each other, simply by rotating the cylindrical member S6 about the long axis direction. Further, the angles of the mirrors S25 and S26 are adjusted so that light having passed through the central core S11 is reflected 90 degrees by each mirror.

In FIG. 4, two mirrors are used so that light emitted from the central core S11 is reflected and enters an outer core S12. However, by some other method, a prism may be used, for example, and a mechanism in which light emitted from the central core S11 enters an outer core S12 and is optically coupled may be used.

The optical path S28 in the optical coupling portion S10 is now described. Light having passed through the central core S11 is reflected 90 degrees twice by the light reflecting portion S17 using the two mirrors S25 and S26 formed on the light reflecting portion S17. As the light reflected twice is made to enter one of the outer cores S12, the one outer core S12 and the central core S11 are coupled with each other to form one optical path S28. Although the optical path S28 exits the central core S11 and enters an outer core S12 in FIG. 4, light emitted from an outer core S12 may be reflected by the mirrors S25 and S26, and enter the central core S11.

As illustrated in FIG. 4, in the optical coupling portion S10, the multi-core optical fiber S4 is incorporated into a ferrule S15. The end face of the ferrule S15 is polished, and is coated with an antireflective film S16 for reducing Fresnel reflection with an air layer. By some other method for reducing Fresnel reflection, oblique polishing in which the ferrule end face is not flat and is polished at a constant angle can be used instead. In this case, however, it is necessary to adjust the later-described gap S5, the polishing angle, and the shapes of the mirrors S25 and S26 of the cylindrical member S6 so that the mirrors S25 and S26 of the cylindrical member S6 do not come into contact with the end face of the ferrule S15 when the cylindrical member S6 rotates.

Next, the optical coupling portion S10 according to the embodiment of the present invention is described with reference to FIG. 5. Note that the cylindrical member S6 in FIG. 5 is the same as that shown in FIG. 4, but the mirrors S25 and S26 formed on the light reflecting portion S17 are not shown. The optical coupling portion S10 further includes the ferrule S15 having the multi-core optical fiber S4 therein, and a cylindrical sleeve S19 into which the ferrule S15 and the cylindrical member S6 are inserted so that the end face of the multi-core optical fiber S4 and the light reflecting portion S17 having the mirrors S25 and S26 formed thereon face each other. There is a predetermined gap (a clearance S40) between the outer circumference of the cylindrical member S6 and the inner circumference of the sleeve.

The optical coupling portion S10 uses the ferrule S15, the cylindrical member S6, and the sleeve S19, to prevent axial misalignment of the multi-core optical fiber S4 and the cylindrical member S6. To control axial misalignment of the ferrule S15 and the cylindrical member S6 to fall within a certain allowable range and not to hinder the axial rotation of the cylindrical member S6, the sleeve S19 makes its sleeve inner diameter S21 about a submicron longer than the cylindrical member outer diameter S20 of the cylindrical member S6, to provide the small clearance S40 (the predetermined gap) of about a submicron. Here, about a submicron means 0.1 to 1 µm.

The optical coupling portion S10 has a gap S5 formed between the end face of the ferrule S15 and the light reflecting portion S17 of the cylindrical member S6. As illustrated in FIG. 5, the gap S5 is characteristically secured by the sleeve axial length S24 of the sleeve S19, a ferrule flange S22 attached to the ferrule S15, and a cylindrical member flange S23 attached to the cylindrical member S6. Specifically, the sleeve axial length S24 of the sleeve S19 is designed to be longer than the sum of the length of the portion of the ferrule S15 protruding from the ferrule flange S22 and the length of the portion of the cylindrical member S6 protruding from the cylindrical member flange S23, so that the gap S5 can be secured.

Note that zirconia is used for the ferrule, the sleeve, and the cylindrical member, but some other material can be used as long as the ferrule, the sleeve, and the cylindrical member can be manufactured with high dimensional accuracy.

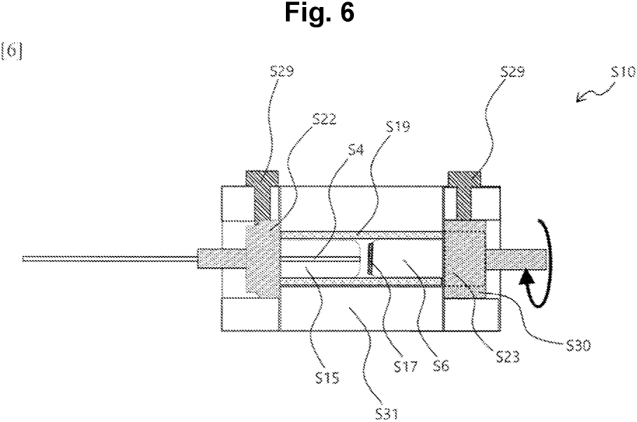

The optical switches S00 and S03 according to this embodiment are illustrated in FIG. 6. The optical switches S00 and S03 characteristically include the rotation mechanism S7 that rotates the multi-core optical fiber S4 or the cylindrical member S6 in an axial direction of the multi-core optical fiber S4 in the optical coupling portion S10, to switch the optical path S28. The following is a description of an example structure in which the optical switches S00 and S03 fix the ferrule S15 and rotate the cylindrical member S6 as in the structure described so far.

Specifically, the ferrule S15 according to this embodiment is attached to the ferrule flange S22 having a portion cut off. The ferrule flange S22 may be attached to a fixing jig S31 with a fixing screw S29, to fix the axial direction and the axial rotation of the ferrule S15. Here, the ferrule flange S22, the fixing screw S29, and the fixing jig S31 constitute the anti-rotation mechanism S3 described above. The optical switches S00 and S03 according to this embodiment further include the cylindrical member flange S23 that holds the cylindrical member S6 via a flange bearing S30. The cylindrical member S6 is attached to the cylindrical member flange S23. The flange bearing S30 is provided on an outer side of the cylindrical member flange S23. The flange bearing S30 is attached to the fixing jig S31 with the fixing screw S29. Here, the cylindrical member flange S23, the fixing screw S29, and the flange bearing S30 constitute the rotation mechanism S7 described above. The sleeve S19 is incorporated into the fixing jig S31, and the ferrule S15 and the cylindrical member S6 are inserted into the sleeve S19 so that axial alignment is conducted.

The optical switch (S00, S03) characteristically further includes the actuator S8 that rotates the rotation mechanism S7 at constant angle steps, and stops the rotation mechanism S7 at a desired angle step.

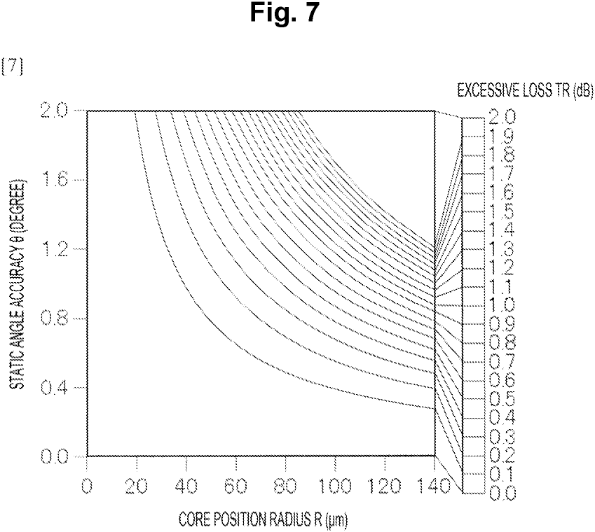

The requirements relating to the actuator S8, the multi-core optical fiber S4, and the cylindrical member S6 are now described with reference to FIG. 7. The actuator S8 is a drive mechanism that rotates at appropriate angle steps in accordance with a pulse signal supplied from the control circuit S9, and has a constant static torque at each angle step. For example, a stepping motor is used. Note that some other method may be used, as long as the actuator S8 is a drive mechanism that rotates at appropriate angle steps in accordance with a pulse signal supplied from the control circuit S9, and has a constant static torque at each angle step. The rotation speed and the rotation angle may be determined by the cycles and the number of pulses of the pulse signal from the control circuit S9, and the angle steps and the static torque may be adjusted via a reduction gear. Since the cylindrical member S6 in the optical coupling portion S10 is designed to rotate freely in an axial direction as described above, the static torque necessary for holding the rotation angle of the cylindrical member S6 is characteristically generated by the actuator S8.

Here, in the stepping motor, the number of angle steps indicating the angular position when the power supply is stopped is defined as the number of static angle steps. That is, the number of static angle steps indicates in how many steps 360 degrees are represented. For example, in a case where the number of static angle steps is four, the angular position at the time of a power supply stop with a specific angular position at 0 degrees (reference) is expressed as 90 degrees = first step, 180 degrees = second step, 270 degrees = third step, and 360 degrees = fourth step. Note that the specific angular position is desirably an angular position at which one of the outer cores S12 and the mirror S26 face each other. Also, the angular position when the power supply is stopped is defined as the static angular position. The static angular position is defined as ((360/ the number of static angle steps) × N), N being a natural number. When the power supply is stopped, the stepping motor rotates the cylindrical member S6 until the cylindrical member S6 reaches the static angular position, and then ends the rotation. The stepping motor characteristically makes the number of static angle steps equal to the number of the cores of the multi-core optical fiber S4 so that one of the outer cores S12 and the mirror S26 face each other when the cylindrical member S6 stops at the static angular position.

Further, in a case where the excessive loss caused by rotational angle deviation in the optical coupling portion S10 is denoted by TR (unit: dB), the static angle accuracy of the stepping motor is denoted by θ (unit: degree), and the size of the core position radius S13 of the multi-core optical fiber S4 is denoted by R (unit: µm), the relationship among these items can be expressed as in Expression 1.

$${\text{T}}_{R} = {\left(\frac{2 {w}_{1} {w}_{2}}{{w}_{1} {}^{2} + {w}_{2} {}^{2}}\right)}^{2} e x p \left[1 \frac{2 {\left(2 R sin 2 π \frac{θ}{360}\right)}^{2}}{{w}_{1} {}^{2} + {w}_{2} {}^{2}}\right] \qquad \text{[Mathematical Expression 1]}$$

Where the excessive loss T is 0.1 dB or 0.2 dB, for example, the maximum static angle accuracy θ is defined with respect to the size R of the core position radius S13 as illustrated in FIG. 7. As can be seen from FIG. 7, the larger the core position radius S13 is, the higher the static angle accuracy is expected to be. For example, if the excessive loss is 0.1 dB, the static angle accuracy needs to be about 0.8 degrees or smaller when the core position radius S13 is 50 µm.

A rotating operation of the cylindrical member S6 according to this embodiment is now described with reference to FIGS. 1, 2, 4, and 6. As illustrated in FIG. 2, the optical switches S00 and S03 attach the actuator S8 to the cylindrical member S6 to which the rotation mechanism S7 is attached, and transmit a signal from the control circuit S9 to the actuator S8, to cause the actuator S8 to rotate the cylindrical member S6. Further, as illustrated in FIG. 6, the flange bearing S30 attached to the cylindrical member flange S23 rotates the cylindrical member flange S23 and the cylindrical member S6.

An example operation of the optical switches S00 and S03 according to this embodiment is now described with reference to FIGS. 2 and 6.

The optical switch S00 is explained herein. In the optical switch S00, a single-core optical fiber connected to the central core S11 of the input/output single-core optical fiber S1 illustrated in FIG. 2 is an input single-core optical fiber (not shown), and a plurality of single-core optical fibers connected to the outer cores is output single-core optical fibers (not shown). Further, the input single-core optical fiber is connected to the input-side optical fiber S01 shown in FIG. 1, and each of the plurality of output single-core optical fibers is connected to the inter-optical-switch optical fiber S02 shown in FIG. 1.

In the optical switch S00, light is input from the input single-core optical fiber to the central core S11 via the fan-in or fan-out optical device S2. As illustrated in FIG. 4, the optical switch S00 uses the mirrors S25 and S26 of the light reflecting portion S17 to reflect the light that has been input to the central core S11 and passed through the central core S11, and causes the light to enter one of the outer cores S12, so that the central core S11 and one of the outer cores S12 are coupled with each other to form one optical path S28. The light that has entered the outer core S12 passes through the outer core S12, and is output from the output single-core optical fiber. In the optical switch S00 according to this embodiment, when light is reflected by the light reflecting portion S17, the cylindrical member S6 is rotated by the actuator S8, the light having passed through the central core S11 is reflected toward an outer core S12 different from that prior to the rotation, and the central core S11 and the outer core S12 different from that prior to the rotation are newly coupled with each other to form one optical path. Thus, optical paths are switched.

In the optical switch S03, on the other hand, a plurality of single-core optical fibers connected to the outer cores S12 of the input/output single-core optical fiber S1 illustrated in FIG. 2 is input single-core optical fibers (not shown), and a single-core optical fiber connected to the central core S11 is an output single-core optical fiber (not shown). Further, each optical fiber of the plurality of input single-core optical fibers is connected to the inter-optical-switch optical fiber S02 shown in FIG. 1, and the output single-core optical fiber is connected to the output-side optical fiber S04 shown in FIG. 1.

In the optical switch S03, light is input from one of the input single-core optical fibers to the outer core S12 via the fan-in or fan-out optical device S2. The optical switch S03 uses the light reflecting portion S17 to reflect the light that has been input to one of the outer cores S12 and passed through the one outer core S12, and causes the light to enter the central core S11, so that the central core S11 and one of the outer cores S12 are coupled with each other to form one optical path. The coupled optical path extends in the opposite direction from the optical path S28 illustrated in FIG. 4. The light that has entered the central core S11 passes through the central core S11, and is output from the output single-core optical fiber. In the optical switch S03 according to this embodiment, when light is reflected by the light reflecting portion S17, the cylindrical member S6 is rotated by the actuator S8, the light having passed through an outer core S12 different from that prior to the rotation is reflected toward the central core S11, and the outer core S12 different from that prior to the rotation and the central core S11 are newly coupled with each other to form one optical path. Thus, optical paths are switched.

Although an example structure in which the cylindrical member S6 is rotated has been described above, the same applies to a structure in which the cylindrical member S6 is fixed and the ferrule S15 is rotated. When the ferrule S15 is rotated instead of the cylindrical member S6, the optical switches S00 and S03 according to this embodiment may further include a ferrule flange S22 that holds the ferrule S15 via a bearing.

An optical switch like the optical switch S00 can be used as a 1×N relay-type optical switch having a single input. It is also possible to form an N×N optical switch by combining optical switches so as to connect the output single-core optical fiber of the Nx1 optical switch S03 and the input single-core optical fiber of the 1xN optical switch S00.

According to the present invention, a mechanism for easily rotating only either the multi-core optical fiber S4 or the cylindrical member S6 in an axial direction, and a gap and a clearance for eliminating any loss associated with rotation are provided. Thus, the energy required by the actuator, which is the torque output, can be minimized, and power consumption can be lowered. Also, the amount of optical axis misalignment in a direction other than the direction of axial rotation of the cylindrical member S6 is restricted by the sleeve S19 in the optical coupling portion S10. Thus, stable optical characteristics can be achieved to cope with external factors such as vibration. Further, the optical switches S00 and S03 do not include any special anti-vibration mechanism. Accordingly, the optical switches S00 and S03 that are economical and compact with excellent assembly workability can be formed with general materials widely used in optical connector products and optical switch products, such as ferrules, sleeves, and mirrors.

Also, in a case where the cylindrical member S6 is rotated as in this embodiment, it is possible to solve the problem of twisting caused in the optical fiber by the repetitive switching through the rotation when the optical fiber is rotated.

Thus, according to the present invention, it is possible to provide an optical switch that has low power consumption, and can achieve stable optical characteristics to cope with external factors with a mechanism that does not require any complicated assembly process.

### Second Embodiment

The following is a detailed description of the configurations and operations of optical switches S00 and S03 according to this embodiment, with reference to FIGS. 2, 8, and 9. The optical switches S00 and S03 of this embodiment differ from the optical switches S00 and S03 of the first embodiment only in the rotation mechanism of the cylindrical member S6 of the optical coupling portion S10. In the description below, the rotation mechanism of the cylindrical member S6 is explained. Note that contents other than those described below are the same as those of the first embodiment.

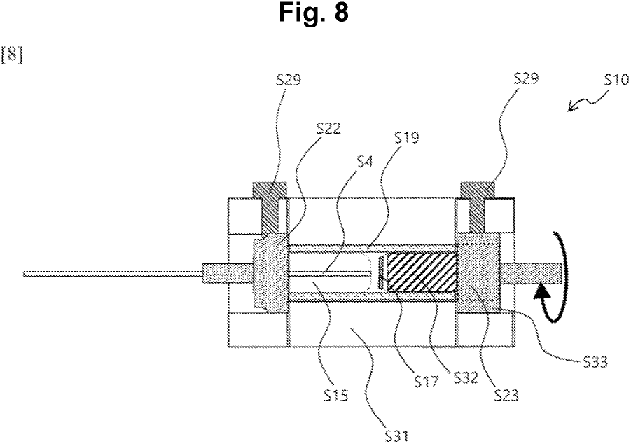

FIG. 8 illustrates an engaged mode of the optical coupling portion S10 according to this embodiment. In the optical switches S00 and S03 according to this embodiment, the ferrule S15 is attached to the ferrule flange S22 having a portion cut off, and the ferrule flange S22 is attached to the fixing jig S31 with the fixing screw S29, as in the first embodiment. The outer diameter of the cylindrical member S6 is smaller than the outer diameter of the ferrule S15. In the optical coupling portion S10 according to this embodiment, the cylindrical member S6 includes a cylindrical member bearing S32 between the inner diameter of the sleeve S19 and the outer diameter of the cylindrical member S6. The cylindrical member S6 is attached to the cylindrical member flange S23. A flange rotating jig S33 is attached to the cylindrical member flange S23. The flange rotating jig S33 is attached to the fixing jig S31 with the fixing screw S29. Here, the cylindrical member flange S23, the fixing screw S29, the cylindrical member bearing S32, and the flange rotating jig S33 constitute the rotation mechanism S7. The optical coupling portion S10 has a structure in which the gap S5 is secured between the end face of the ferrule S15 and the light reflecting portion S17 of the cylindrical member S6 by the ferrule flange S22 and the cylindrical member flange S23, as in the first embodiment.

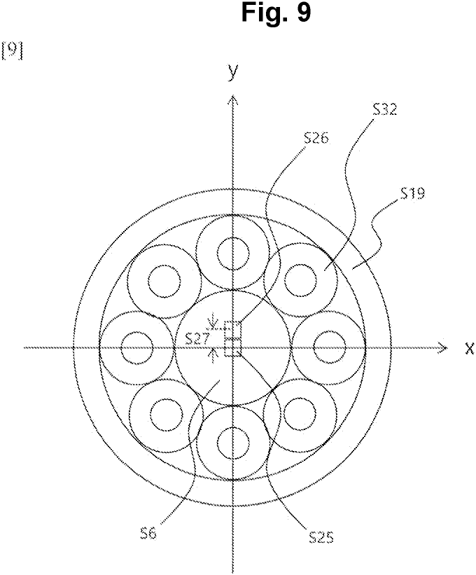

FIG. 9 illustrates a front view of the light reflecting portion S17 of the optical coupling portion S10 according to this embodiment. In the structure, the cylindrical member bearing S32 is attached around the cylindrical member S6, and the cylindrical member S6 can freely rotate inside the sleeve S19.

Note that zirconia is used for the cylindrical member bearing S32, for example, but some other material can be used as long as the cylindrical member bearing S32 can be manufactured with high dimensional accuracy.

A rotating operation of the cylindrical member S6 according to this embodiment is now described with reference to FIGS. 2 and 8. As illustrated in FIG. 2, the optical switches S00 and S03 attach the same actuator S8 as that of the first embodiment to the cylindrical member S6 to which the rotation mechanism S7 of this embodiment is attached, and transmit a signal from the control circuit S9 to the actuator S8, to cause the actuator S8 to rotate the cylindrical member S6. Further, as illustrated in FIG. 8, the cylindrical member bearing S32 and the flange rotating jig S33 rotate the cylindrical member flange S23 and the cylindrical member S6.

The optical switches S00 and S03 according to this embodiment output input light as in the first embodiment. In the optical switch S00 according to this embodiment, when light is reflected by the light reflecting portion S17, the cylindrical member S6 is rotated by the actuator S8 as described above, so that optical paths can be switched as in the first embodiment.

As described above, according to the present invention, it is possible to provide an optical switch that has low power consumption, and can achieve stable optical characteristics to cope with external factors with a mechanism that does not require any complicated assembly process.

Note that the respective inventions described above can be combined as appropriate.

### INDUSTRIAL APPLICABILITY

The optical switch according to the present disclosure can minimize the drive energy when switching optical paths, and can provide an optical switch with low power consumption. Also, it is possible to provide an optical switch that is compact and economical being formed with widely used optical connection components, and further achieves stable optical characteristics to cope with external factors such as temperature and vibration. As a result, in an optical fiber line using single-mode optical fibers in an optical fiber network, the optical switch according to the present disclosure can be used as an optical switch that switches paths in any facility regardless of places.

Reference Signs List

| | |
|---|---|
| S00 | former-stage optical switch |
| S01 | input-side optical fiber |
| S02 | inter-optical-switch optical fiber |
| S03 | latter-stage optical switch |
| S04 | output-side optical fiber |
| S1 | input/output single-core optical fiber |
| S2 | fan-in or fan-out optical device |
| S3 | anti-rotation mechanism |
| S4 | bundled optical fiber formed by melting and |
| stretching a multi-core optical fiber including a plurality | |
| of cores or a plurality of single-core optical fibers | |
| S5 | gap |
| S6 | cylindrical member |
| S7 | rotation mechanism |
| S8 | actuator |
| S9 | control circuit |
| S10 | optical coupling portion |
| S11 | central core |
| S12 | outer core |
| S13 | core position radius |
| S14 | optical fiber cladding diameter |
| S15 | ferrule |
| S16 | antireflective film |
| S17 | light reflecting portion |
| S19 | sleeve |
| S20 | cylindrical member outer diameter |
| S21 | sleeve inner diameter |
| S22 | ferrule flange |
| S23 | cylindrical member flange |
| S24 | sleeve axial length |
| S25 | mirror |
| S26 | mirror |
| S27 | light-reflective center-to-center distance |
| S28 | optical path |
| S29 | fixing screw |
| S30 | flange bearing |
| S31 | fixing jig |
| S32 | cylindrical member bearing |
| S33 | flange rotating jig |
| S40 | clearance |
| S41 | center cladding |
| S42 | outer cladding |

1. An optical switch comprising:
an optical coupling portion that includes: a multi-core optical fiber that has a central core at a center of an optical fiber and a plurality of outer cores on a circumference of the identical circle centering around the optical fiber in a fiber cross-section; a mirror that is disposed in front of an end face of the multi-core optical fiber, and couples one of the outer cores with the central core to form one optical path; and a cylindrical member that has an end face to which the mirror is fixed; and
a rotation mechanism that rotates the multi-core optical fiber or the cylindrical member in an axial direction of the multi-core optical fiber, and switches the optical path in the optical coupling portion.

2. The optical switch according to claim 1, wherein
the optical coupling portion further includes:
a ferrule in which the multi-core optical fiber is provided; and
a cylindrical sleeve into which the ferrule and the cylindrical member are inserted, the end face of the multi-core optical fiber and the mirror facing each other, and
a predetermined gap is formed between an outer diameter of the cylindrical member and an inner diameter of the sleeve.

3. The optical switch according to claim 1 wherein
an end on an opposite side of the multi-core optical fiber from the end face included in the optical coupling portion is connected to a fan-in or fan-out optical device connected to an input/output single-core optical fiber having a single core.

4. The optical switch according to claim 1 further comprising
a flange that holds the cylindrical member via a bearing.

5. The optical switch according to claim 2, further comprising
a flange that holds the ferrule via a bearing.

6. The optical switch according to claim 1, further comprising
an actuator that rotates the rotation mechanism at constant angle steps, and stops the rotation mechanism at a desired angle step.
